(19) United States
(12) Patent Application Publication
(10) Pub. No.: US 2024/0296505 A1
(43) Pub. Date: Sep. 5, 2024

(54) DIVERSITY CREDIT SYSTEM AND METHODS

(71) Applicant: UNM Rainforest Innovations, Albuquerque, NM (US)

(72) Inventors: Mitzi Montoya, Albuquerque, NM (US); Craig G. White, Albuquerque, NM (US); Audrey Iffert-Saleem, Albuquerque, NM (US)

(73) Assignee: UNM Rainforest Innovations, Albuquerque, NM (US)

(21) Appl. No.: 18/590,731

(22) Filed: Feb. 28, 2024

Related U.S. Application Data
(60) Provisional application No. 63/449,084, filed on Mar. 1, 2023.

(51) Int. Cl. G06Q 40/12

(52) U.S. Cl. CPC G06Q 40/12

(57) ABSTRACT

A diversity credit method comprising the steps of: providing one or more diversity credits for purchase.

This application claims priority to U.S. Provisional Application No. 63/449,084 filed on Mar. 1, 2023 which is incorporated herein in its entirety.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### FIELD OF THE INVENTION

The invention relates generally to diversity and equity initiatives. More specifically, the invention relates to a credit initiative providing a verifiable mechanism for measuring and reporting diversity and equality compliance.

### BACKGROUND OF THE INVENTION

As a component of multi-faceted strategies to achieve environmental, social and governance (ESG) outcomes, many companies invest in the advancement of diversity, equity and inclusion (DEI) initiatives-often with a focus on recruiting and retaining a racially and ethnically diverse workforce. Yet, research has shown that shifting workforce demographics and advancing inclusion in the workplace is a slow, long-term process. For example, Mckinsey projects that it will take about 95 years for Black employees to be equitably represented across all organizational levels in the private sector, from frontline employee through C-suite executive. Companies pursuing DEI work currently lack the means to demonstrate immediate impacts of racial and ethnic equity initiatives when reporting on their ESG commitments.

Minority-Serving Institutions (MSIs), colleges and universities that serve high percentages of Asian/Pacific-Islander, Black, Hispanic and/or Native students, are a powerful force for educating racial and ethnic minorities and advancing a workforce of color. Overall, about 28 percent of all U.S. undergraduate students attend an MSI, adding up to nearly five million students of color overall.

Higher education has long been known as key to American middle-class mobility and economic stability, and MSIs are especially strong catalysts for upward economic and social mobility. Students who attend four-year MSIs are three times more likely to come from families in the lowest income quintile than their peers at four-year non-MSI institutions. The mobility of students who attend four-year MSIs is two to three times higher than students who attend four-year non-MSIs.

In spite of the fundamental economic value they offer, MSIs are historically underfunded when compared to predominantly white institutions (PWIs). By investing in racial and ethnic equity and purchasing diversity credits from MSIs, companies can take immediate action to address educational disparities while investing in the innovative and creative solutions of their future diverse workforce. Investment in minority-majority MSIs, where over 50 percent of the student body identifies as a racial or ethnic minority, deepens the initiative's impact, ensuring that funding supports educational institutions that serve the highest percentage of minority students.

What is needed is a credit initiative providing a verifiable mechanism for measuring and reporting diversity and equality compliance so that companies pursuing DEI work can demonstrate immediate impacts of racial and ethnic equity initiatives when reporting on their ESG commitments. The present invention satisfies this need.

### BRIEF SUMMARY OF THE INVENTION

In one embodiment, the present invention concerns a diversity credit method comprising the steps of providing one or more diversity credits for purchase.

In another embodiment, the present invention concerns a diversity credit method wherein each diversity credit represents a human capital metric.

In another embodiment, the present invention concerns a diversity credit method wherein each diversity credit represents an environmental metric.

In another embodiment, the present invention concerns a diversity credit method wherein each diversity credit represents a governance metric.

In another embodiment, the present invention concerns a diversity credit method wherein a blockchain is used for quantification and verification of the one or more diversity credits.

In another embodiment, the present invention concerns a diversity credit method comprising the steps of: auditing the racial and ethnic demographics of its workforce at each level of an organization including hourly employees, salaried employees, managers, senior leaders and board members; determining the gap between the number of said organization's managers, senior leaders and board members that identify as Hispanic or Black and the number that said organization's constituents would expect it to employ; and obtaining diversity credits which represent said determined gap.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 illustrates an embodiment of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention

According to the invention, diversity education credits offer a verifiable mechanism for measuring and reporting diversity and equity considerations as part of a broader set of ESG strategies. While organizations engage in the internal work to create a more diverse and equitable organization in the future, diversity credits provide an immediate, impactful action along the way-directing capital to projects that address racial and ethnic equity today.

According to the invention, a company may purchase a specific number of diversity credits from verified activities at minority-majority MSIs. This allows the company to move more quickly toward their diversity-related human capital ESG goals, as well as engage with MSI partners to assess and improve the organization's racial and ethnic equity-related ESG goals and practices. According to an embodiment of the invention, one diversity education credit equals one graduate of color at a minority-majority MSI. Companies would establish goals as part of diversity-related human capital ESG efforts, assess current performance relative to goals, and purchase a specific number of diversity credits from verified activities at minority-majority MSIs. These credits would immediately offset current gaps in an organization's own performance on racial/ethnic equity-related ESG commitments while providing broader ecosystem benefits, positively impacting the families of students, enhancing MSI faculty research, deepening student and faculty support of local minority-owned businesses, and boosting the economies within which MSIs are located.

The Anderson School of Management at UNM is uniquely qualified to lead the effort to generate, quantify and verify a standard for diversity credits that is aligned with the dominant standard-setting organizations (e.g., SASB, GRI, IIRC, and the new Value Reporting Foundation). The Anderson School is accredited by the AACSB, the highest standard of achievement for business schools worldwide, and is a minority-majority school at a Carnegie-designated Research 1 university. Anderson is poised to launch a nationwide, standardized diversity education credit program that is informed by the needs and lived experiences of a diverse student population. The program will be designed with a coalition of minority-majority MSIs from which credits can be purchased. The solution will be built on a blockchain-based tracking system to ensure transparency, traceability and audit-ability.

Because MSIs are non-profit organizations, purchase of diversity credits would qualify as a tax-deductible charitable contribution. However, through policy innovation, the purchase of diversity credits may eventually qualify as a tax-deductible business expense.

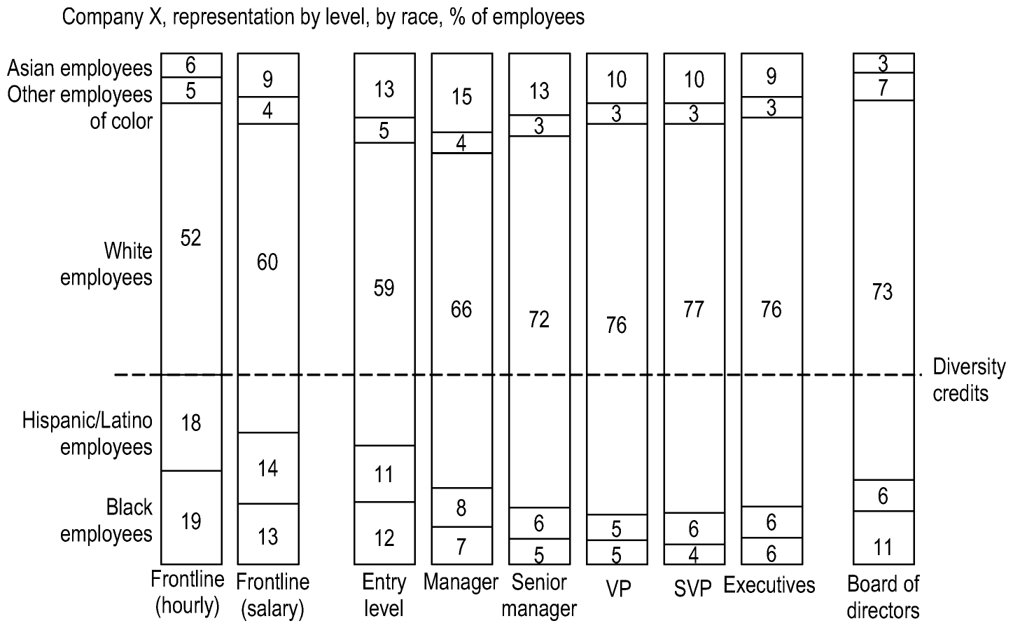

Further details of the invention are provided in FIG. 1 entitled University of New Mexico Diversity Credit Initiative.

Now described is an example of the diversity credit system and methods according to an embodiment of the invention. Company X is a U.S. retail chain that has 100,000 employees, where 70 percent work in front-line hourly positions. Frontline employees' racial and ethnic demographics roughly mirror the demographics of the retailer's customers, unlike the demographics of Company X's management, senior leadership and board.

Company X audits the racial and ethnic demographics of its workforce at each level of the organization and executes a plan to address inequities in its hiring, pay and promotion practices. Company X purchases 10,000 diversity credits, which represents the current gap between the number of Company X managers, senior leaders and board members that identify as Hispanic or Black and the number that Company X's constituents would expect it to employ, based on the demographics of Company X consumers. This example is graphically represented in FIG. 1.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A diversity credit method comprising the steps of: providing one or more diversity credits for purchase.

2. The method the method of claim 1 wherein each diversity credit represents a human capital metric.

3. The method the method of claim 1 wherein each diversity credit represents an environmental metric.

4. The method the method of claim 1 wherein each diversity credit represents a governance metric.

5. The method the method of claim 1 wherein a blockchain is used for quantification and verification of the one or more diversity credits.

6. A diversity credit method comprising the steps of:
auditing the racial and ethnic demographics of its workforce at each level of an organization including hourly employees, salaried employees, managers, senior leaders and board members;
determining the gap between the number of said organization's managers, senior leaders and board members that identify as Hispanic or Black and the number that said organization's constituents would expect it to employ; and
obtaining diversity credits which represent said determined gap.

7. The method the method of claim 6 wherein each diversity credit represents a human capital metric.

8. The method the method of claim 6 wherein each diversity credit represents an environmental metric.

9. The method the method of claim 6 wherein each diversity credit represents a governance metric.

10. The method the method of claim 6 wherein a blockchain is used for quantification and verification of the one or more diversity credits.
